(19) United States
(12) Patent Application Publication
(10) Pub. No.: US 2025/0239966 A1
(43) Pub. Date: Jul. 24, 2025

(54) SOLAR MODULE FRAME WITH RAIL FLANGE

(71) Applicant: Nextracker LLC, Fremont, CA (US)

(72) Inventors: Alexander W. AU, Oakland, CA (US); Madeleine Davis Kho, Oakland, CA (US)

(21) Appl. No.: 19/020,492

(22) Filed: Jan. 14, 2025

Related U.S. Application Data
(60) Provisional application No. 63/622,716, filed on Jan. 19, 2024.

(51) Int. Cl. H02S 30/10; F16M 11/10; H02S 20/32

(52) U.S. Cl. CPC H02S 30/10; F16M 11/10; H02S 20/32

(57) ABSTRACT

A solar module frame is configured to bound a plurality of photovoltaic cells. This solar module frame includes a first sidewall at a first side of the frame and a second sidewall at a second side of the frame. Extending out from the first sidewall is a first outward facing lower flange that includes at least one fastening aperture, and extending out from the first sidewall is a first inward facing upper flange that defines a first side photovoltaic cell receptacle. Extending out from the second sidewall is a second outward facing lower flange that includes at least one fastening aperture, and extending out from the second sidewall is a second inward facing upper flange that defines a second side photovoltaic cell receptacle.

### RELATED APPLICATION

This application claims priority to U.S. provisional patent application No. 63/622,716, filed on Jan. 19, 2024, the contents of which are hereby incorporated by reference.

### TECHNICAL FIELD

This disclosure relates generally to device, system, and method embodiments of solar module frames. Solar module frame device, system, and method embodiments disclosed herein can be configured to facilitate more efficient and effective installation to a support structure, such as a torque tube of a solar tracker.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure, via many connection points, the rails at the torque tube and to then place and secure the solar modules at the installed rails. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant labor and cost considerations to a solar tracking system application.

### SUMMARY

This disclosure in general describes device, system, and method embodiments of solar module frames. Solar module frame device, system, and method embodiments disclosed herein can be configured to facilitate more efficient and effective solar module frame installation at a support structure. For example, solar module frame device, system, and method embodiments disclosed herein can be configured to facilitate more efficient and effective solar module frame installation at a torque tube of a solar tracking system. In particular, embodiments can include a solar module frame that is configured for direct mounting to the torque tube (e.g., such that the solar module frame contacts the torque tube directly of via a washer interface component with the torque tube) of a solar tracking system, for instance, such as by including an outward facing lower flange at the solar module frame. The outward facing lower flange at the solar module frame can be configured to receive thereat one or more suitable fastening members that couple the solar module frame, via the outward facing lower flange, directly to the torque tube.

Such embodiments disclosed herein can, for instance, reduce the number of connection points between a solar module frame and a support structure, such as a torque tube, as compared to previous solar module frames. As one example, the outward facing lower flange at solar module frame embodiments disclosed herein can serve as a type of integrated rail for coupling the solar module frame to the torque tube and, thus, the solar module frame embodiments disclosed herein can directly attach to the torque tube via this outward facing lower flange and, as such, can eliminate a need for, and installation of, one or more separate rail components typically used in previous solar tracking systems (e.g., separate rail components associated with each solar module frame in previous solar tracking systems). In addition, such embodiments disclosed herein can provide one or more connection interfaces between the solar module frame embodiments disclosed herein and the support structure, such as a torque tube, that are adapted for autonomous (e.g., robotic) installation. For instance, such embodiments disclosed herein can provide one or more connection interfaces between the solar module frame embodiments disclosed herein and the torque tube adapted for installation orientation for autonomous (e.g., robotic) installation, such as adapted for top-down robotic coupling of the solar module frame embodiments to the support structure.

One embodiment includes a solar module system. This solar module system embodiment includes a first solar module frame and a second solar module frame. The first solar module frame includes: a first sidewall at a first side of the first solar module frame, a second sidewall at a second, opposite side of the first solar module frame, a first outward facing lower flange that extends out from the first sidewall, a first fastening aperture defined at the first outward facing lower flange, and a first inward facing upper flange that extends out from the first sidewall and defines a first photovoltaic cell receptacle. The second solar module frame includes: a third sidewall at a first side of the second solar module frame, a fourth sidewall at a second, opposite side of the second solar module frame, a second outward facing lower flange that extends out from the third sidewall, a second fastening aperture defined at the second outward facing lower flange, and a second inward facing upper flange that extends out from the third sidewall and defines a second photovoltaic receptacle. The first outward facing lower flange of first solar module frame and the second outward facing lower flange of the second solar module frame are configured to overlay one another with the first fastening aperture and the second fastening aperture axially aligned to receive a common fastening member at each of the first fastening aperture and the second fastening aperture.

In a further embodiment of this system, the first outward facing lower flange extends out from the first sidewall at a bottom portion of the first sidewall, and the first inward facing upper flange extends out from the first sidewall at a top portion of the first sidewall spacing apart from the first outward facing lower flange along a length of the first sidewall. For some such embodiments, the first solar module frame can further include a third outward facing lower flange that extends out from the second sidewall and a third fastening aperture defines at the third outward facing lower flange. For some such embodiments, the first solar module frame can yet further include a fourth inward facing upper flange that extends out from the second sidewall and defines a third photovoltaic cell receptacle that is axially aligned at a common elevation with the first photovoltaic cell receptacle.

In a further embodiment of this system, the system can additionally include the common fastening member, and this common fastening member can include a blind rivet inserted at each of the first fastening aperture and the second fastening aperture and set to fasten the first solar module frame and the second solar module frame to a torque tube.

In a further embodiment of this system, the first outward facing lower flange of first solar module frame and the second outward facing lower flange of the second solar module frame overlay and contact one another with the first fastening aperture and the second fastening aperture axially aligned to receive the common fastening member at each of the first fastening aperture and the second fastening aperture.

In a further embodiment of this system, the system additionally includes a lip that extends out from the first sidewall of the first solar module frame in a same direction as the first outward facing lower flange. A flange receptacle space can be defined between the lip, the first outward facing lower flange, and the first sidewall, and this flange receptacle space can receive the second outward facing lower flange of the second solar module frame with the second outward facing lower flange overlaying the first outward facing lower flange. For some such embodiments, the lip extends out from the first sidewall at an elevational location along the first sidewall that is between the first outward facing lower flange and the first inward facing upper flange. For some such embodiments, the lip extends out from the first sidewall a distance that is less than a distance the first outward facing lower flange extends from the first sidewall. For instance, the lip can extend out from the first sidewall the distance that terminates prior to intersecting a central longitudinal axis of the first fastening aperture. Also, for instance, when the common fastening member is received at each of the first fastening aperture and the second fastening aperture, the lip interfaces with the common fastening member.

In a further embodiment of this system, the system additionally includes at least one washer component that contacts at least one of the first outward facing lower flange and the second outward facing lower flange. For example, the at least one washer component can be a first washer component that contacts the first outward facing lower flange, and the system further includes a second washer component that contacts the second outward facing lower flange. The first washer component can contact a torque tube of a solar tracker at one side and contact the first outward facing lower flange at a second, opposite side.

As noted, some embodiments of solar module frames and systems disclosed herein can include at least one lip (e.g., only one lip). This lip can be included at the solar module frame. For example, the lip can be included at the first sidewall of the solar module frame, such as at an elevational location along the first sidewall between an elevational location at the first sidewall of the outward facing lower flange and an elevational location at the first sidewall of the inward facing upper flange. The lip can extend out a distance from the first sidewall that is less than the distance the outward facing lower flange extends from the first sidewall. The lip can be configured to extend out a distance from the first sidewall and terminate at a radial location along that distance prior to intersecting a central longitudinal axis of the fastening aperture that is defined at the outward facing lower flange. The lip can be configured to interface with a fastening member that is inserted at the fastening aperture at the outward facing lower flange.

Another embodiment includes a solar module frame. This embodiment of the solar module frame includes a first sidewall at a first side of the first solar module frame, a second sidewall at a second, opposite side of the first solar module frame, a first outward facing lower flange that extends out from the first sidewall, a first fastening aperture defined at the first outward facing lower flange, a first inward facing upper flange that extends out from the first sidewall and defines thereat a first photovoltaic cell receptacle, a lip that extends out from the first sidewall in a same direction as the first outward facing lower flange, a second outward facing lower flange that extends out from the second sidewall, a second fastening aperture defined at the second outward facing lower flange, and a second inward facing upper flange that extends out from the second sidewall and defines thereat a second photovoltaic cell receptacle that is elevationally aligned with the first photovoltaic cell receptacle.

In a further embodiment of this solar module frame, a flange receptacle space (e.g., as illustrated such as at FIG. 3B) is defined between the lip, the first outward facing lower flange, and the first sidewall. This flange receptacle space is elevationally aligned along the first sidewall with the second outward facing lower flange at the second sidewall (e.g., as illustrated at the example of FIG. 3B). The lip can extend out from the first sidewall at an elevational location along the first sidewall that is between the first outward facing lower flange and the first inward facing upper flange. For instance, the lip can extend out from the first sidewall a distance that is less than a distance the first outward facing lower flange extends from the first sidewall. In one such example, the lip can extend out from the first sidewall the distance that terminates prior to intersecting a central longitudinal axis of the first fastening aperture.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a schematic, perspective view of a solar tracker apparatus.

FIGS. 2A-2I illustrate one embodiment of a solar module frame with an outward facing lower flange. FIG. 2A shows a perspective view and FIG. 2B shows a side elevational view of the solar module frame with outward facing lower flange. FIGS. 2C-2E show an example bottom washer component and a fastening member used to couple solar module frame(s) with outward facing lower flange(s) to a torque tube, with FIG. 2C showing a perspective view, FIG. 2D showing a side elevational view of the fastening member pre-installed, and FIG. 2E showing a side elevational view of the fastening member installed to couple two solar module frames, via their respective outward facing lower flanges, to the washer component and to the torque tube. FIGS. 2F-2G show an example bottom washer component and top washer component as well as a fastening member used to couple solar module frame(s) with outward facing lower flange(s) to a torque tube, with FIG. 2F showing a perspective view and FIG. 2G showing a cross-sectional view of the fastening member installed to couple two solar module frames, via their respective outward facing lower flanges, to the bottom and top washer components and to the torque tube. FIGS. 2H-2I show an example top washer component as well as a fastening member used to couple solar module frame(s) with outward facing lower flange(s) to a torque tube, with FIG. 2H showing a perspective view and FIG. 2I showing a cross-sectional view of the fastening member installed to couple two solar module frames, via their respective outward facing lower flanges, to the top washer component and directly to the torque tube.

FIGS. 3A-3I illustrate another embodiment of a solar module frame with an outward facing lower flange. The embodiment of the solar module frame shown at FIGS. 3A-3I can be similar to, or the same as, the embodiment of the solar module frame shown and described with respect to FIGS. 2A-2I except that the solar module frame embodiment shown at FIGS. 3A-3I can additionally include a lip, for instance, at the outward facing lower flange. FIG. 3A shows a perspective view and FIG. 3B shows a side elevational view of the solar module frame with the outward facing lower flange and lip. FIGS. 3C-3E show an example bottom washer component and a fastening member used to couple solar module frame(s) with outward facing lower flange(s) and lip(s) to a torque tube, with FIG. 3C showing a perspective view, FIG. 3D showing a side elevational view of the fastening member installed to couple two solar module frames, via their respective outward facing lower flanges, to the washer component and to the torque tube with the lip of at least one solar module frame adjacent to the fastening member. FIGS. 3F-3G show an example bottom washer component and top washer component as well as a fastening member used to couple solar module frame(s) with outward facing lower flange(s) and lip(s) to a torque tube, with FIG. 3F showing a perspective view and FIG. 3G showing a cross-sectional view of the fastening member installed to couple two solar module frames, via their respective outward facing lower flanges, to the bottom and top washer components and to the torque tube with the lip of at least one solar module frame adjacent to the fastening member and top washer component. FIGS. 3H-3I show an example top washer component as well as a fastening member used to couple solar module frame(s) with outward facing lower flange(s) to a torque tube, with FIG. 3H showing a perspective view and FIG. 3I showing a cross-sectional view of the fastening member installed to couple two solar module frames, via their respective outward facing lower flanges, to the top washer component and directly to the torque tube with the lip of at least one solar module frame adjacent to the fastening member and top washer component.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

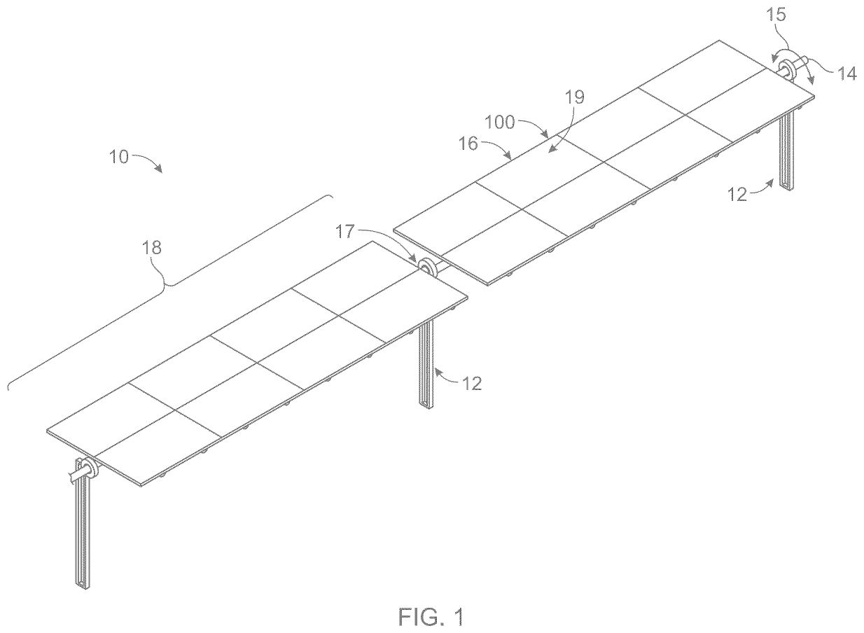

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and can be rotatably supported at each pier 12. The solar tracker apparatus 10 can further include a plurality of solar module frames 16 supported at the respective torque tube 14. The one or more torque tubes 14 can be rotated in directions 15 so as to change an angle of the solar modules 16, such as throughout a day as the location of the sun changes relative to the solar modules 16. A bearing housing assembly 17 can be configured to rotatably connect torque tubes 14 along a span of the solar tracker apparatus 10. The span between two adjacent piers 12 can be referred to as a bay 18 and, for example, each bay 18 can be rotatably connected to an adjacent bay 18 via the bearing housing assembly 17. A plurality of solar tracker apparatus 10 rows may be arranged in a north-south longitudinal orientation to form a solar array.

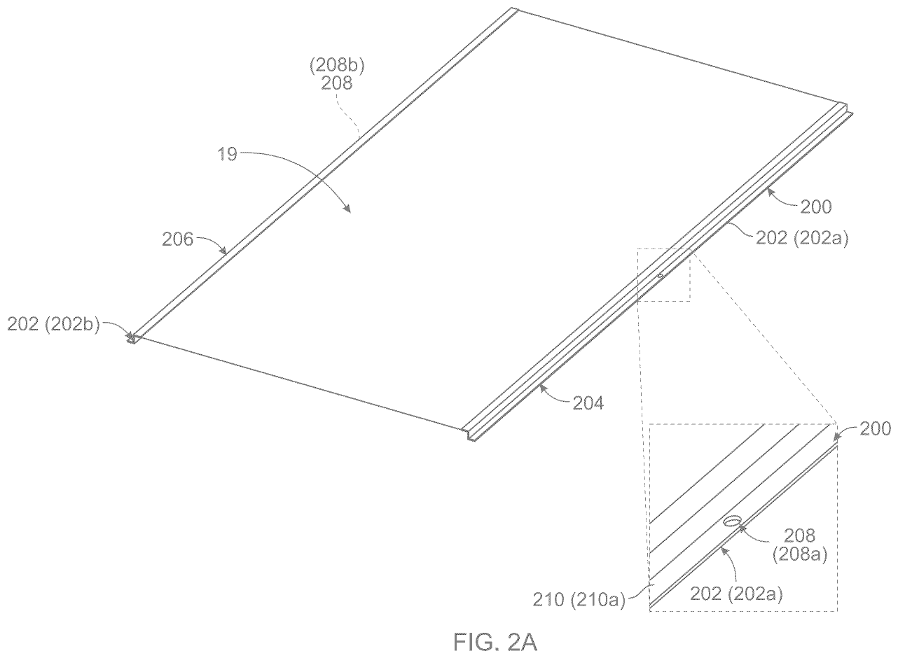

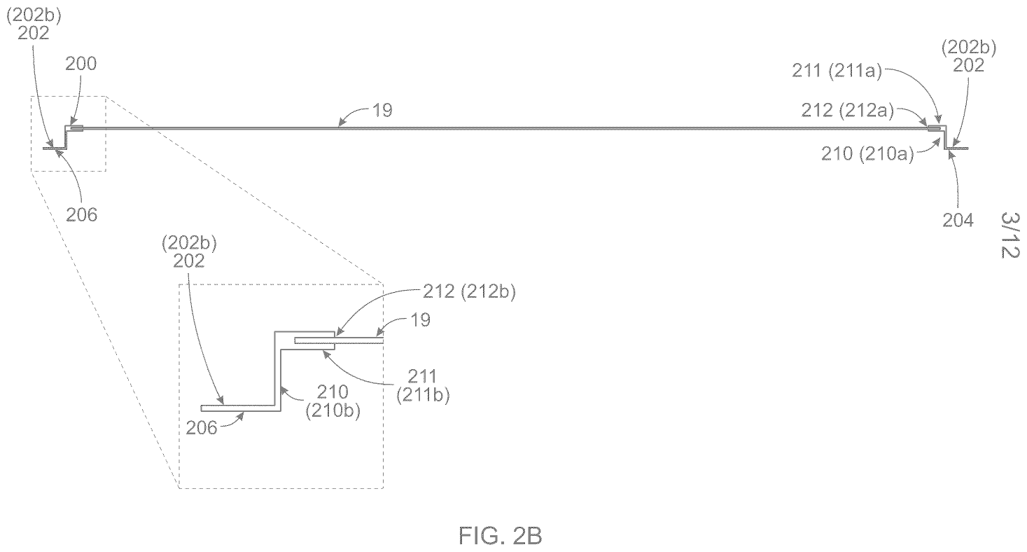

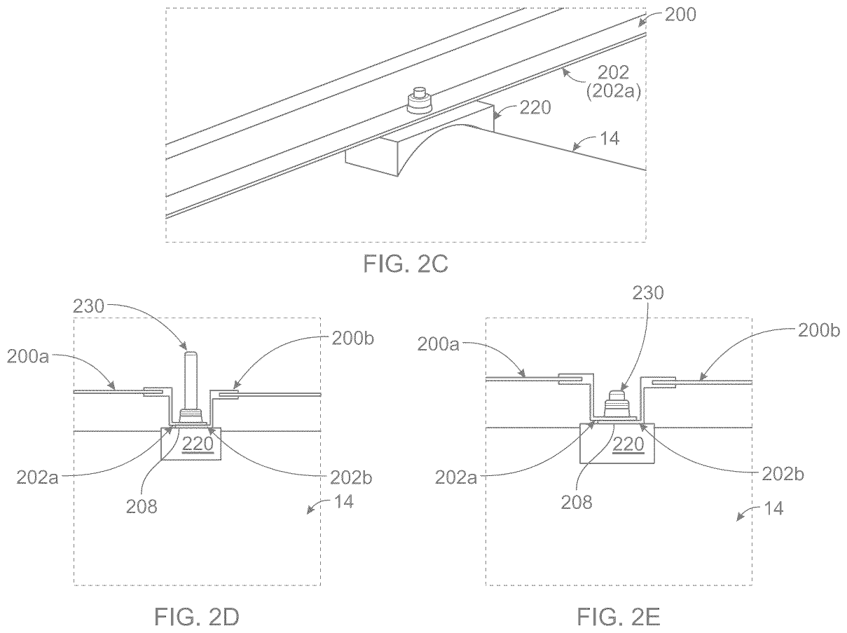

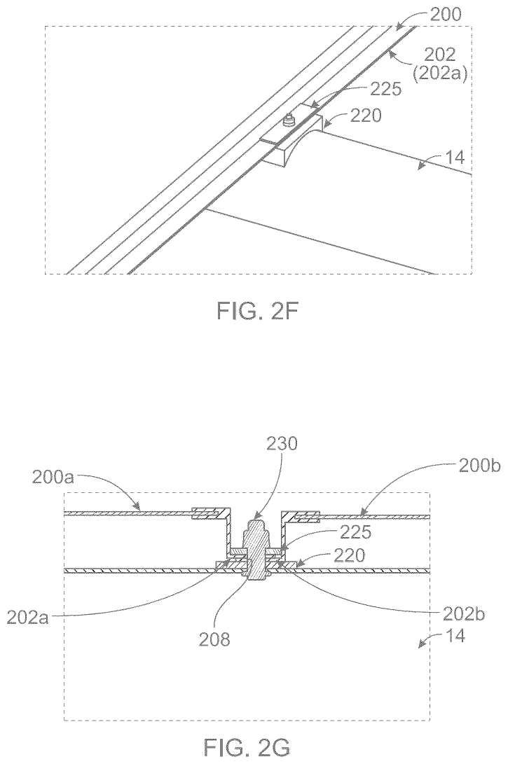

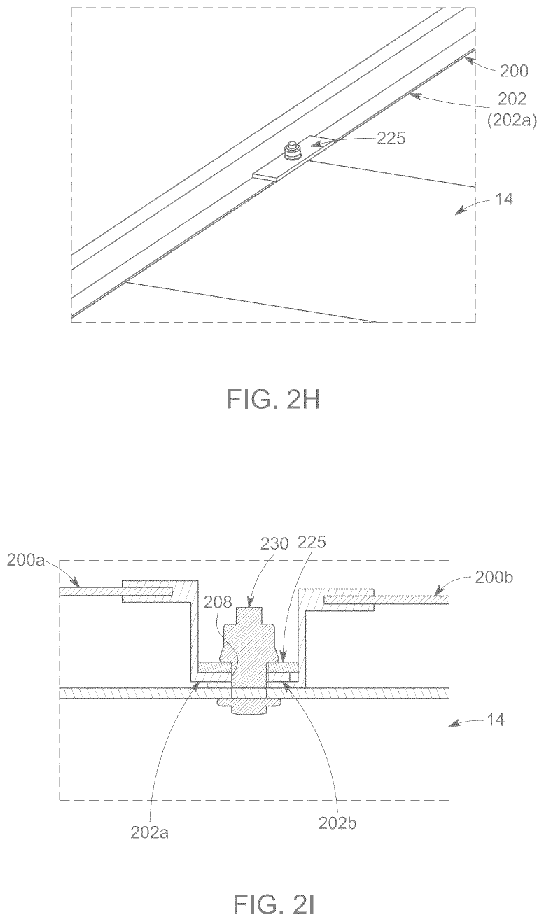

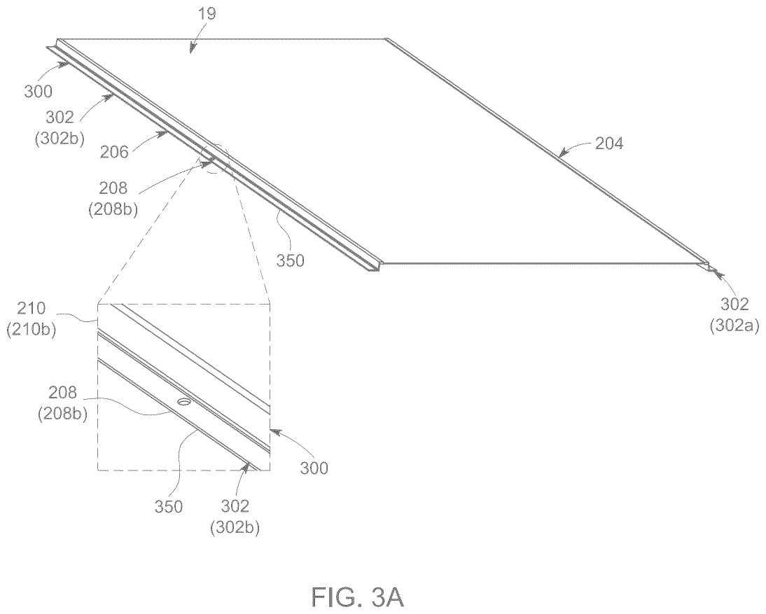

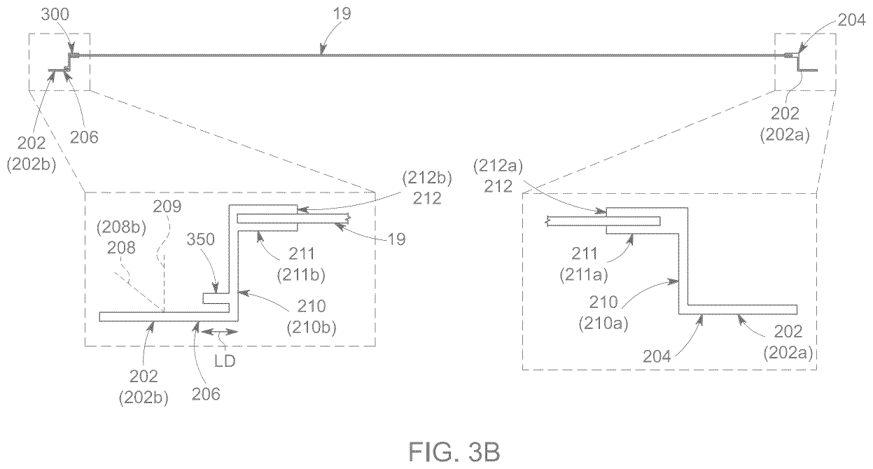

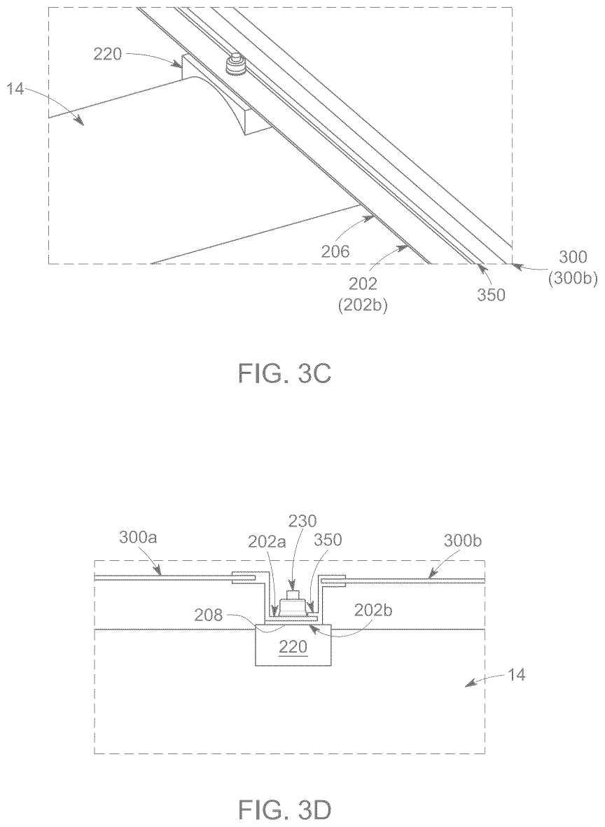

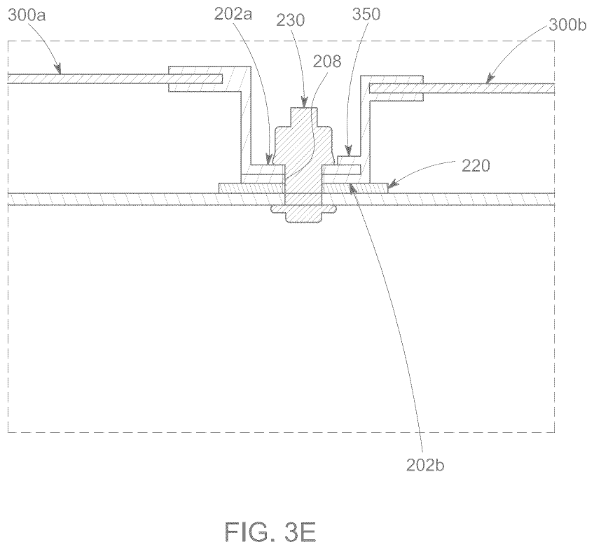

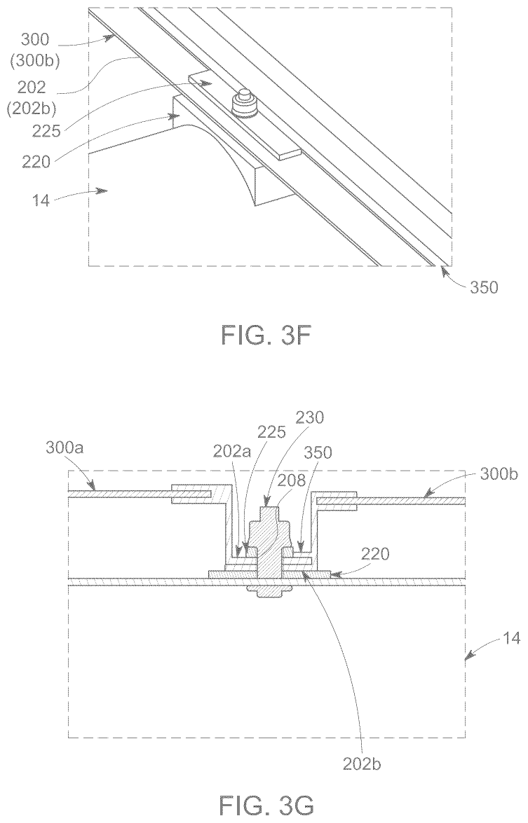

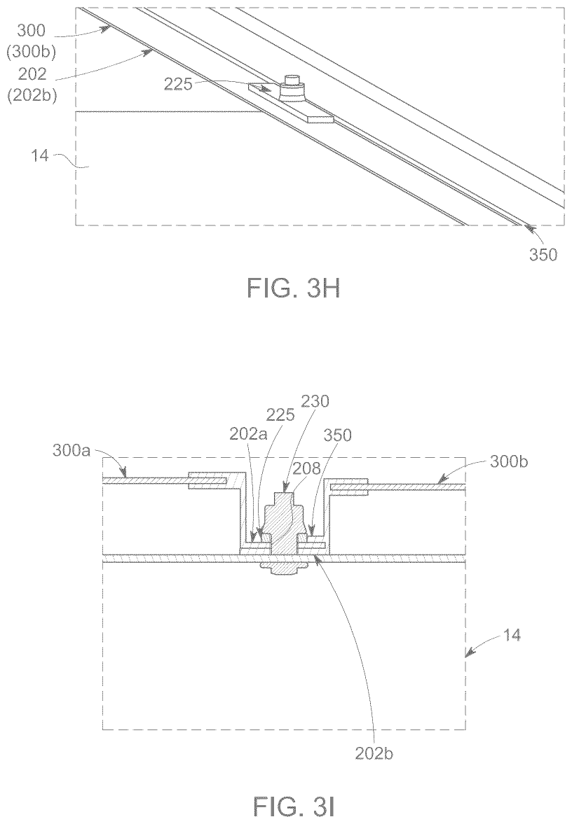

Each solar module frame 16 can include a frame 100 that is coupled to the torque tube 14 as well as a plurality of photovoltaic cells 19 bounded by the frame 100. The example shown at FIG. 1 illustrates pairs of solar module frames 16 mounted to the torque tube 14 in a landscape orientation, though embodiments (e.g., those shown at FIGS. 2A-2I and/or those shown at FIGS. 3A-3I) within the scope of the present disclosure can include solar module frames 16 mounted to the torque tube 14 in a side-by-side portrait orientation. As will be described herein, in some instances, the solar module frame 100 can be directly coupled to the torque tube 14 (e.g., such that the solar module frame 100 contacts the torque tube, for instance, such that the outward facing lower flange at the solar module frame 100 contacts the torque tube 14) and in other instances the solar module frame 100 can be indirectly coupled to the torque tube 14 by coupling the solar module frame 100 directly to a washer component, adjacent frame, and/or other suitable intermediate component and coupling that intermediate component to the torque tube 14. As will also be described herewith, in various embodiments, adjacent solar module frames 100 of adjacent solar modules 16 can be coupled together, for instance, using a single fastening member.

The following disclosure will describe various solar module frame embodiments that can be used, for instance, in a solar tracker apparatus. Such embodiments disclosed herein can, for example, be useful in facilitating more labor-efficient solar module frame installation at a solar tracker apparatus. The following description will describe a variety of solar module frame embodiments for coupling one or more solar module frames to a support structure, which in the solar tracker apparatus example applications referenced herein is a torque tube.

FIGS. 2A-2I illustrate one embodiment of a solar module frame 200 with an outward facing lower flange 202.

FIG. 2A shows a perspective view and FIG. 2B shows a side elevational view of the solar module frame 200 with outward facing lower flange 202. The solar module frame 200 can bound a plurality of photovoltaic cells 19 and thus form a solar module 16 that can be mounted to the torque tube 14. The solar module frame 200 can include a first side 204 and a second, opposite side 206. The illustrated embodiment of the solar module frame 200 includes the outward facing lower flange 202 at both the first side 204—outward facing lower flange 202a—and the second side 206—outward facing lower flange 202b. As best seen at FIG. 2B, the outward facing lower flange 202 can extend outward from a sidewall 210 of the solar module frame 200. For example, the first side 204 of the solar module frame 200 can include a first sidewall 210a and the second side 206 of the solar module frame 200 can include a second sidewall 210b. The outward facing lower flange 202a can extend out from the first sidewall 210a (e.g., extend out from the first sidewall 210a at a perpendicular orientation), and the outward facing lower flange 202b can extend out from the second sidewall 210b (e.g., extend out from the first sidewall 210a at a perpendicular orientation). The illustrated embodiment shows that the first sidewall 210a has the outward facing lower flange 202a extending out from the first sidewall 210a at or near a bottom surface of the first sidewall 210a and the first sidewall 210a further includes an inward facing upper flange 211a. The inward facing upper flange 211a can extend out from the first sidewall 210a in a direction opposite the outward facing lower flange 202a and at or near a top surface of the first sidewall 210a. Likewise, the illustrated embodiment shows that the second sidewall 210b has the outward facing lower flange 202b extending out from the second sidewall 210b at or near a bottom surface of the second sidewall 210b and the second sidewall 210b further includes an inward facing upper flange 211b. The inward facing upper flange 211b can extend out from the second sidewall 210b in a direction opposite the outward facing lower flange 202b and at or near a top surface of the second sidewall 210b. The inward facing upper flange 211a can define a first side photovoltaic cell (e.g., photovoltaic cell laminate) receptacle 212a, and the inward facing upper flange 211b can define a second side photovoltaic cell (e.g., photovoltaic cell laminate) receptacle 212b.

To help facilitate coupling the solar module frame 200 (e.g., coupling the solar module) to the torque tube (e.g., directly or indirectly), the outward facing lower flange 202 can include one or more flange fastening apertures 208 (e.g., one fastening aperture 208a at the outward facing lower flange 202a at the first side 204 and one fastening aperture 208b at the outward facing lower flange 202b at the second side 206). For instance, the one or more fastening apertures 208 can be centered along a width of the outward facing lower flange 202 and the one or more fastening apertures 208 can extend through a thickness of the outward facing lower flange 202.

The solar module frame 200 can be configured to couple to the torque tube 14. FIGS. 2C-2E show an example bottom washer component 220 and a fastening member 230 (e.g., a blind fastening member, such as blind rivet) used to couple solar module frame(s) 200 with outward facing lower flange(s) 202 to the torque tube 14, with FIG. 2C showing a perspective view, FIG. 2D showing a side elevational view of the fastening member 230 pre-installed at the solar module frame 200, and FIG. 2E showing a side elevational view of the fastening member 230 installed to couple two solar module frames 200a, 200b, via their respective, interfacing outward facing lower flanges 202a, 202b, to the washer component 220 and to the torque tube 14. As shown for the illustrated example, the washer component 220 and the fastening member 230 can couple both first and second solar module frames 200a, 200b to the torque tube 14. The bottom washer component 220 can include a bottom surface that is configured to sit on the torque tube 14, and this bottom surface of the bottom washer component 220 can define a cross-sectional profile (e.g., semi-circular) that matches a cross-sectional profile of the torque tube 14 (e.g., semi-circular) where the bottom washer component 220 is to sit. For example, outward facing lower flange 202a of first solar module frame 200a and outward facing lower flange 202b of second solar module frame 200b can interface at the washer component 220, such as with the outward facing lower flange 202a of first solar module frame 200a and outward facing lower flange 202b of second solar module frame 200b overlaying one another (e.g., contacting one another) as shown for the illustrated embodiment. The outward facing lower flange 202a of first solar module frame 200a and outward facing lower flange 202b of second solar module frame 200b can overlay one another with the fastening apertures 208 at each of the outward facing lower flange 202a and the outward facing lower flange 202b axially aligned with one another to facilitate reception of the fastening member 230. Thus, a single fastening member 230 can be configured to couple a pair of solar module frames 200a, 200b to the torque tube 14 using the interfacing outward facing lower flanges 202a, 202b at the pair of solar module frames 200a, 200b.

FIGS. 2F-2G show an example bottom washer component 220 and top washer component 225 as well as the fastening member 230 used to couple solar module frames 200a, 200b with respective, interfacing outward facing lower flanges 202a, 202b to the torque tube 14. FIG. 2F shows a perspective view and FIG. 2G shows a cross-sectional view of the fastening member 230 installed to couple two solar module frames 200a, 200b, via their respective outward facing lower flanges 202a, 202b, to the bottom and top washer components 220, 225 and to the torque tube 14. The bottom washer component 220 can be similar to, or the same as, that described previously. The top and bottom washer components 220, 225 can each include a fastening aperture that is configured to receive thereat the fastening member 230. The top washer component 225 can be positioned on an opposite side of the interfacing outward facing lower flanges 202a, 202b relative to the bottom washer component 220. The outward facing lower flange 202a of first solar module frame 200a and outward facing lower flange 202b of second solar module frame 200b can interface at the bottom and top washer components 220, 225, such as with the outward facing lower flange 202a of first solar module frame 200a and outward facing lower flange 202b of second solar module frame 200b overlaying one another (e.g., contacting one another) as shown for the illustrated embodiment. The top washer component 225 can be at a top side (e.g., contacting a top side) of the overlaid outward facing lower flange 202a, 202b, and the bottom washer component 220 can be at a bottom side (e.g., contacting a bottom side) of the overlaid outward facing lower flange 202a, 202b. The outward facing lower flange 202a of first solar module frame 200a and outward facing lower flange 202b of second solar module frame 200b overlaying one another with the fastening apertures 208 at each of the outward facing lower flange 202a and the outward facing lower flange 202b axially aligned with one another to facilitate reception of the fastening member 230 through the overlaid outward facing lower flange 202a, 202b and through the top and bottom washer components 220, 225. Thus, a single fastening member 230 can be configured to couple a pair of solar module frames 200a, 200b to the torque tube 14 using the interfacing outward facing lower flanges 202a, 202b at the pair of solar module frames 200a, 200b and top and bottom washer components 220, 225.

FIGS. 2H-2I show an example top washer component 225 as well as fastening member 230 used to couple solar module frames 200a, 200b with outward facing lower flanges 202a, 202b to the torque tube 14, with FIG. 2H showing a perspective view and FIG. 2I showing a cross-sectional view of the fastening member 230 installed to couple two solar module frames 200a, 200b, via their respective outward facing lower flanges 202a, 202b, to the top washer component 225 and directly to the torque tube 14. The top washer component 225 can be similar to, or the same as, that described previously. The top washer component 225 can be positioned on an opposite side of the interfacing outward facing lower flanges 202a, 202b relative to the torque tube 14. The outward facing lower flange 202a of first solar module frame 200a and outward facing lower flange 202b of second solar module frame 200b can interface at the top washer component 225, such as with the outward facing lower flange 202a of first solar module frame 200a and outward facing lower flange 202b of second solar module frame 200b overlaying one another (e.g., contacting one another) as shown for the illustrated embodiment. The top washer component 225 can be at a top side (e.g., contacting a top side) of the overlaid outward facing lower flange 202a, 202b, and the torque tube 14 can be at a bottom side (e.g., contacting a bottom side) of the overlaid outward facing lower flange 202a, 202b. The outward facing lower flange 202a of first solar module frame 200a and outward facing lower flange 202b of second solar module frame 200b overlaying one another with the fastening apertures 208 at each of the outward facing lower flange 202a and the outward facing lower flange 202b axially aligned with one another to facilitate reception of the fastening member 230 through the overlaid outward facing lower flange 202a, 202b and through the top washer component 225. Thus, a single fastening member 230 can be configured to couple a pair of solar module frames 200a, 200b to the torque tube 14 using the interfacing outward facing lower flanges 202a, 202b at the pair of solar module frames 200a, 200b and top washer component 225 to directly couple the pair of solar module frames 200a, 200b to the torque tube 14.

FIGS. 3A-3I illustrate another embodiment of solar module frame 300 with outward facing lower flange 202 and, for this solar module frame 300 embodiment, additionally include at least one lip 350. Thus, the embodiment of the solar module frame 300 shown at FIGS. 3A-3I can be similar to, or the same as, the embodiment of the solar module frame 200 shown and described with respect to FIGS. 2A-2I except that the solar module frame 300 shown at FIGS. 3A-3I can additionally include the lip 350, for instance, at the outward facing lower flange 202.

FIG. 3A shows a perspective view and FIG. 3B shows a side elevational view of the solar module frame 300 with the outward facing lower flange 202 and lip 350. The solar module frame 300 can be similar to, or the same as, the solar module frame 200 except that the solar module frame 300 includes at least one lip 350. As such, the same reference characters used in FIGS. 2A-2I are used at FIGS. 3A-3I to indicate the same features. The lip 350 can be located, for example, at the outward facing lower flange 202. The illustrated embodiment includes the at least one lip 350 at only one side of the solar module frame 300, for instance, as shown here the side 206 (and thus there is no lip, and only the outward facing lower flange 202a and inward facing upper flange 211a, at the other side 204 of the frame 300).

The lip 350 can, for example, be included at the sidewall 210 (e.g., second sidewall 210b) of the solar module frame 300. In various examples, the lip 350 can extend out from the sidewall 210 (e.g., second sidewall 210b) of the solar module frame 300, such as at an elevational location along the sidewall 210 between an elevational location at the sidewall 210 of the outward facing lower flange 202 (e.g., second outward facing lower flange 202b) and an elevational location at the sidewall 210 of the inward facing upper flange 211 (e.g., second inward facing upper flange 211b). The lip 350 can extend out a distance LD from the sidewall 210 that is less than the distance the outward facing lower flange 202 extends from the sidewall 210. As one such example, the lip 350 can extend out the distance LD from the sidewall 210 and terminate at a radial location along that distance LD prior to intersecting a central longitudinal axis 209 of the fastening aperture 208 (e.g., fastening aperture 208b) that is defined at the outward facing lower flange 202 (e.g., outward facing lower flange 202b). The lip 350 can be configured to interface with the fastening member 230 that is inserted at the fastening aperture 208 at the outward facing lower flange 202. When a top washer component is included (e.g., such as shown at FIGS. 3F-3I), the lip 350 can be configured to interface with the fastening member 230 that is inserted at the fastening aperture 208 at the outward facing lower flange 202 and with the top washer component.

FIGS. 3C-3E show an example bottom washer component 220 and fastening member 230 used to couple solar module frame(s) 300 with outward facing lower flange(s) 202 and lip(s) 350 to the torque tube 14, with FIG. 3C showing a perspective view, FIG. 3D showing a side elevational view of the fastening member 230 installed to couple two solar module frames 300a, 300b, via their respective outward facing lower flanges 202a, 202b and at least one lip 350, to the washer component 220 and to the torque tube 14. As noted, each solar module frame 300 can include lip 350 at one side (e.g., lip 350 at side 206) but not at an opposite side (e.g., no lip at side 204). Accordingly, when two such solar module frames 300a, 300b and placed at the torque tube 14 (e.g., at the washer 220 at the torque tube 14) one interfacing side of one such solar module frame 300b (e.g., sidewall 210b) can include lip 350 while another interfacing side of another such solar module frame 300a (e.g., sidewall 210a) can lack any lip 350, resulting in a pair of interfacing outward facing lower flanges 202a, 202b of respective solar module frames 300a, 300b and one lip 350 placed at the torque tube 14 (e.g., at the washer 220 at the torque tube 14). As illustrated here, the lip 350 of one solar module frame 300b can be located adjacent to the fastening member 230. As also illustrated here, additionally or alternatively to the lip 350 being located adjacent to the fastening member 230, as illustrated here the lip 350 included at the solar moule frame 300b (e.g., at the sidewall 210b of the solar module frame 300b) can interface with outward facing lower flange 202a of the another solar module frame 300a.

FIGS. 3F-3G show an example bottom washer component 220 and top washer component 225 as well as fastening member 230 used to couple solar module frame(s) 300a, 300b with outward facing lower flange(s) 202a, 202b and at least one lip 350 to the torque tube 14. FIG. 3F shows a perspective view and FIG. 3G shows a cross-sectional view of the fastening member 230 installed to couple two solar module frames 300a, 300b, via their respective outward facing lower flanges 200a, 200b and interfacing lip 350, to the bottom and top washer components 220, 225 and to the torque tube 14. As seen here, the lip 350 of at least one solar module frame 300b can be located adjacent to the fastening member 230 and top washer component 225. In particular, in this embodiment, the lip 350 can overlay the outward facing lower flange 200a of another, adjacent solar module frame 300a and be adjacent to the fastening member 230. This can include the lip 350 overlaying the outward facing lower flange 200a of another, adjacent solar module frame 300a and this outward facing lower flange 200a of the another, adjacent solar module frame 300a can overlay the outward facing lower flange 200b of the solar module frame 300b that includes the lip 350. Thus, when the pair of solar module frames 300a, 300b are coupled to the torque tube 14 using the top and/or bottom washer components 220, 225, a stacked, overlaid arrangement adjacent to the fastening member 230 can include, from top to bottom, the lip 350 of the solar module frame 300b, the outward facing lower flange 200a of the solar module frame 300a, and the outward facing lower flange 200b of the solar module frame 300b that includes the lip 350. The top washer component 225, when included, can be at a common elevation, relative to this stacked, overlaid arrangement, at least with the lip 350.

FIGS. 3H-3I show an example top washer component 225 as well as fastening member 230 used to couple solar module frames 300a, 300b with outward facing lower flanges 202a, 202b and lip 350 to torque tube 14. FIG. 3H shows a perspective view and FIG. 3I shows a cross-sectional view of the fastening member 230 installed to couple two solar module frames 300a, 300b, via their respective outward facing lower flanges 202a, 202b and lip 350, to the top washer component 225 and directly to the torque tube 14 with the lip 350 of at least one solar module frame 300b adjacent to the fastening member 230 and top washer component 225. The top washer component 225 can be positioned on an opposite side, relative to the torque tube 14, of the interfacing outward facing lower flanges 202a, 202b, and the top washer component 225 can be adjacent to the lip 350. The outward facing lower flange 202a of first solar module frame 300a, the outward facing lower flange 202b of second solar module frame 300b, and the lip 350 of the second solar module frame 300b can interface at or near the top washer component 225, such as with the lip 350 of the second solar module frame 300b, the outward facing lower flange 202a of first solar module frame 300a, and the outward facing lower flange 202b of second solar module frame 300b overlaying one another (e.g., contacting one another) as shown for the illustrated embodiment. The top washer component 225 can be at a top side (e.g., contacting a top side) of the overlaid outward facing lower flange 202a, 202b and adjacent to the lip 350, and the torque tube 14 can be at a bottom side (e.g., contacting a bottom side) of the overlaid lip 350 and outward facing lower flanges 202a, 202b. The lip 350, the outward facing lower flange 202a, and outward facing lower flange 202b can overlay one another with the fastening apertures 208 at each of the outward facing lower flange 202a and the outward facing lower flange 202b axially aligned with one another to facilitate reception of the fastening member 230 through the overlaid outward facing lower flange 202a, 202b and through the top washer component 225 and with the lip 350 terminating prior to intersecting the axial location of the fastening apertures 208. Thus, a single fastening member 230 can be configured to couple a pair of solar module frames 300a, 300b to the torque tube 14 using the interfacing lip 350 and outward facing lower flanges 202a, 202b at the pair of solar module frames 300a, 300b and top washer component 225 to directly couple the pair of solar module frames 300a, 300b to the torque tube 14.

Various examples have been described. These and other examples are within the scope of the following claims.

What is claimed is:

1. A solar module system comprising:
a first solar module frame comprising:
a first sidewall at a first side of the first solar module frame,
a second sidewall at a second, opposite side of the first solar module frame,
a first outward facing lower flange that extends out from the first sidewall,
a first fastening aperture defined at the first outward facing lower flange, and
a first inward facing upper flange that extends out from the first sidewall and
defines a first photovoltaic cell receptacle; and
a second solar module frame comprising:
a third sidewall at a first side of the second solar module frame,
a fourth sidewall at a second, opposite side of the second solar module frame,
a second outward facing lower flange that extends out from the third sidewall,
a second fastening aperture defined at the second outward facing lower flange,
and
a second inward facing upper flange that extends out from the third sidewall and defines a second photovoltaic receptacle
wherein the first outward facing lower flange of first solar module frame and the second outward facing lower flange of the second solar module frame are configured to overlay one another with the first fastening aperture and the second fastening aperture axially aligned to receive a common fastening member at each of the first fastening aperture and the second fastening aperture.

2. The system of claim 1, wherein the first outward facing lower flange extends out from the first sidewall at a bottom portion of the first sidewall, and wherein the first inward facing upper flange extends out from the first sidewall at a top portion of the first sidewall spacing apart from the first outward facing lower flange along a length of the first sidewall.

3. The system of claim 2, wherein the first solar module frame further comprises a third outward facing lower flange that extends out from the second sidewall and a third fastening aperture defines at the third outward facing lower flange.

4. The system of claim 3, wherein the first solar module frame further comprises a fourth inward facing upper flange that extends out from the second sidewall and defines a third photovoltaic cell receptacle that is axially aligned at a common elevation with the first photovoltaic cell receptacle.

5. The system of claim 1, further comprising the common fastening member, wherein the common fastening member comprises a blind rivet inserted at each of the first fastening aperture and the second fastening aperture and set to fasten the first solar module frame and the second solar module frame to a torque tube.

6. The system of claim 1, wherein the first outward facing lower flange of first solar module frame and the second outward facing lower flange of the second solar module frame overlay and contact one another with the first fastening aperture and the second fastening aperture axially aligned to receive the common fastening member at each of the first fastening aperture and the second fastening aperture.

7. The system of claim 1, further comprising:
a lip that extends out from the first sidewall of the first solar module frame in a same direction as the first outward facing lower flange.

8. The system of claim 7, wherein a flange receptacle space is defined between the lip, the first outward facing lower flange, and the first sidewall, and wherein the flange receptacle space receives the second outward facing lower flange of the second solar module frame with the second outward facing lower flange overlaying the first outward facing lower flange.

9. The system of claim 8, wherein the lip extends out from the first sidewall at an elevational location along the first sidewall that is between the first outward facing lower flange and the first inward facing upper flange.

10. The system of claim 7, wherein the lip extends out from the first sidewall a distance that is less than a distance the first outward facing lower flange extends from the first sidewall.

11. The system of claim 10, wherein the lip extends out from the first sidewall the distance that terminates prior to intersecting a central longitudinal axis of the first fastening aperture.

12. The system of claim 11, wherein, when the common fastening member is received at each of the first fastening aperture and the second fastening aperture, the lip interfaces with the common fastening member.

13. The system of claim 1, further comprising at least one washer component that contacts at least one of the first outward facing lower flange and the second outward facing lower flange.

14. The system of claim 13, wherein the at least one washer component is a first washer component that contacts the first outward facing lower flange, and wherein the system further comprises a second washer component that contacts the second outward facing lower flange.

15. The system of claim 14, wherein the first washer component contacts a torque tube at one side and contacts the first outward facing lower flange at a second, opposite side.

16. A solar module frame comprising:
a first sidewall at a first side of the first solar module frame;
a second sidewall at a second, opposite side of the first solar module frame;
a first outward facing lower flange that extends out from the first sidewall;
a first fastening aperture defined at the first outward facing lower flange;
a first inward facing upper flange that extends out from the first sidewall and defines thereat a first photovoltaic cell receptacle;
a lip that extends out from the first sidewall in a same direction as the first outward facing lower flange;
a second outward facing lower flange that extends out from the second sidewall;
a second fastening aperture defined at the second outward facing lower flange; and
a second inward facing upper flange that extends out from the second sidewall and defines thereat a second photovoltaic cell receptacle that is elevationally aligned with the first photovoltaic cell receptacle.

17. The frame of claim 16, wherein a flange receptacle space is defined between the lip, the first outward facing lower flange, and the first sidewall, and wherein the flange receptacle space is elevationally aligned along the first sidewall with the second outward facing lower flange at the second sidewall.

18. The frame of claim 17, wherein the lip extends out from the first sidewall at an elevational location along the first sidewall that is between the first outward facing lower flange and the first inward facing upper flange.

19. The frame of claim 16, wherein the lip extends out from the first sidewall a distance that is less than a distance the first outward facing lower flange extends from the first sidewall.

20. The frame of claim 19, wherein the lip extends out from the first sidewall the distance that terminates prior to intersecting a central longitudinal axis of the first fastening aperture.
